(19) United States
(12) Patent Application Publication
(10) Pub. No.: US 2021/0336344 A1
(43) Pub. Date: Oct. 28, 2021

(54) A Patch Antenna Composed of Bonding Wires and Its Application

(71) Applicant: Innovation Sound Technology Co., LTD., Guangdong (CN)

(72) Inventors: Shunming YUEN, Guangdong (CN); Wai Yin MUNG, Guangdong (CN); Ka Ming WU, Guangdong (CN)

(21) Appl. No.: 16/610,976

(22) PCT Filed: Aug. 29, 2018
(86) PCT No.: PCT/CN2018/102930

§ 371 Date: Nov. 5, 2019

(30) Foreign Application Priority Data
Aug. 24, 2018 (CN) 201810975883.6

(51) Int. Cl. H01Q 9/04; H01Q 1/38; H01Q 5/314

(52) U.S. Cl. CPC H01Q 9/0421; H01Q 5/314; H01Q 1/38

(57) ABSTRACT

The present invention discloses a patch antenna composed of several sets of bonding wires connected to each other. The bonding wires are combined into different antenna lengths, and are disposed in radiating slots on one side of the patch. The present invention adopts a mode in which bonding wires are directly combined into an antenna, and patch antennas with different combined bonding wires bear different frequencies. Therefore, in the production, the PCB structure can be designed first, and then the antenna frequency can be designed by product requirements, so that different wireless communications are satisfied, especially the use of millimeter wave radar antennas. Since the antenna is completely composed of bonding wires, when there is a signal input, the current flows from bottom to top in the bonding wires 1, resulting in a higher axial ratio. Furthermore, since the wavelength of high frequencies is short, the antenna of the present invention may be made very small in size.

### FIELD OF THE INVENTION

The present invention relates to the field of wireless communication technologies, and in particular to a patch antenna composed of bonding wires and its application.

### BACKGROUND OF THE INVENTION

Millimeter waves (mmWave) represent the next radio technology, with a 10-times increase in frequency and a 10-times increase in signal bandwidth compared to the most advanced Wi-Fi and 4G technologies. The current 4G network operates in the 700 MHz to 2.6 GHz band, while millimeter waves will operate over a nearly 20 GHz underutilized spectrum in 28 GHz, 39 GHz and 60 GHz bands. The millimeter-wave wireless technology provides companies with a range of mobile data rates up to multiple Gbps in the development of new wireless products.

The millimeter wave technology can provide higher data rates and better spectral efficiencies, thus enhancing existing base stations and providing new applications. The successful deployment and acceptance will depend on its proven performance and reliability, which can only be achieved with complicated test equipment. Despite a large number of usage scenarios, this equipment must be able to provide extensive testing quickly and efficiently.

As an expected next wireless initiative for a few years to come, 5G will incorporate the millimeter-wave band employing “new radio (NR)” technology. The technology seamlessly combines authorizations, and shares licensed and unlicensed spectrums across radio technologies. 5G base stations will support and transparently interface with old technologies, therefore the millimeter wave technology will be widely applied.

Since the length and width of the patch antenna are of finite lengths, there is a phenomenon of fringing field, called fringing effect, in the field (radiating slots) near the metal edge of the antenna patch. FIG. 1 and FIG. 2 are schematic diagrams for the structure and equivalent transmission line model of a conventional patch antenna, respectively. Since the metal edge does not store charge to maintain a potential balance, a vast amount of charge would accumulate at the edge to form a capacitive effect, which can be equivalent to a length of tiny microstrip transmission line. Radiation mainly comes from the fringing field (radiating slots) between the edge of the above planar conductor and the earthing metal plane. The working principle of the patch antenna is that when waves are transmitted online in half-wavelength multiples, nodes are generated at the position of half-wavelength multiples, and standing waves are generated between nodes. Assuming that the transmission line is an ideal conductor, standing waves will never disappear, and the amplitude and phase will never change. Therefore, using this principle, the patch antenna length (L) is designed to be a half-wavelength length, and the transmission line is used to transmit waves to the patch antenna, so that the wave resonates at the two open ends of the antenna. However, since the patch antenna is not an enclosed transmission line, waves are radiated out from the open end edge by means of the equivalent antenna structure of transmission lines of radiating slots.

FIG. 3 shows the current distribution of the existing antenna on signal input. Current flows from bottom to top, so linear polarization occurs and the axial ratio is not high.

### DESCRIPTION OF THE INVENTION

The present invention aims to provide a patch antenna composed of bonding wires, and its application to solve the problem brought up in the above background technology.

To achieve the above object, the present invention provides the following technical schemes:

A patch antenna composed of several sets of bonding wires, which are connected to each other, combined into different antenna lengths, and disposed in radiation slots on one side of the patch.

As a further scheme of the invention, the manner in which the bonding wires are combined into different antenna lengths includes a combination of different numbers of bonding wires (1), a combination of the bonding wires with different lengths, and a combination of the bonding wires with different heights.

The application of a patch antenna comprising bonding wires in the millimeter wave technology.

Compared with the prior art, the beneficial effects of the present invention are as follows:

The present invention adopts a mode in which bonding wires are directly combined into an antenna, and patch antennas with different combined bonding wires bear different frequencies. Therefore, in the production, the PCB structure can be designed first, and then the antenna frequency can be designed by product requirements, so that different wireless communications are satisfied, especially the use of millimeter wave radar antennas. Since the antenna is completely composed of bonding wires, when there is a signal input, current flows from bottom to top in the bonding wire, resulting in a higher axial ratio. Furthermore, since the wavelength of high frequencies is short, the antenna of the present invention may be made very small in size.

### BRIEF INTRODUCTION OF THE DRAWINGS

FIG. 1 is a structural schematic diagram of the existing patch antenna.

FIG. 2 is a structural schematic diagram for an equivalent transmission line model of the existing patch antenna.

FIG. 3 is a schematic diagram for the current distribution of the existing patch antenna.

FIG. 4 is a structural schematic diagram of a patch antenna composed of bonding wires in the present invention.

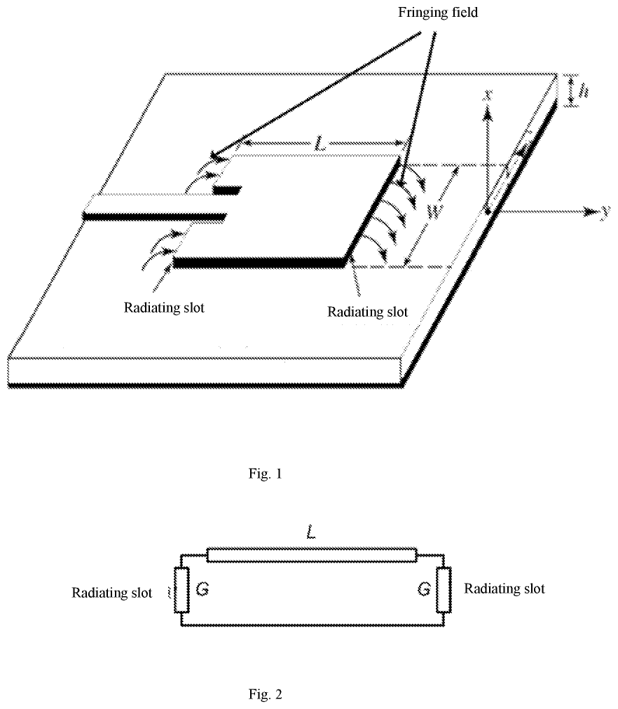

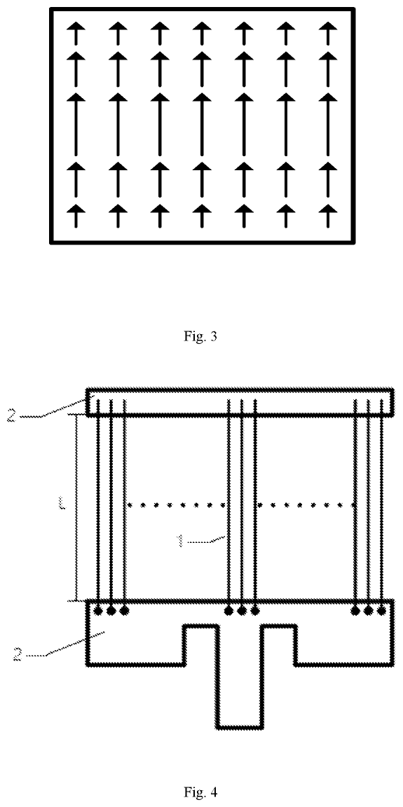

### DETAILED EMBODIMENT

The technical scheme in the embodiment of the present invention will be clearly and completely described as follows with reference to the accompanying drawings. Apparently, the described embodiments are only a part of that of the invention, and not all of them. All other embodiments obtained by those skilled in the art based on the embodiments of the present invention without making creative efforts shall fall within the scope of protection of the present invention.

Refer to FIG. 4 for a patch antenna, proposed in the embodiment of the present invention, composed of several sets of bonding wires 1, which are connected to each other and disposed in radiation slots on one side of the patch 2.

A patch antenna with a length of L composed of several sets of bonding wires 1, specifically including the antenna comprising different numbers of bonding wires 1, the antenna comprising different lengths of bonding wires or the antenna with different heights of bonding wires. The patch antenna thus designed bears different frequencies. Therefore, in the production, the PCB structure can be designed first, and then the antenna frequency can be designed by product requirements, so that different wireless communications are satisfied, especially the use of millimeter wave radar antennas. In addition, since the antenna is completely composed of bonding wires, when there is a signal input, current flows from bottom to top in the bonding wires 1, resulting in a higher axial ratio.

For those skilled in the art, apparently the present invention is not limited to the details given in the above exemplary embodiments. The present invention can be embodied in other specific forms without departing from the spirit or essential characteristics of the invention. Therefore, the embodiments shall be considered as exemplary and unrestricted in any way. The scope of the invention is defined by the appended claims rather than the above description. Hence, all changes intended to come within the meaning and range of equivalent elements of the claims shall be included within the invention. Any marks on drawings to the Claims shall not be construed as limiting the Claims involved.

Furthermore, it shall be understood that although the Specification is described in terms of embodiments, not every embodiment includes only one independent technical scheme. The description style in the Specification is for clarity only. Those skilled in the art shall take the Specification as a whole. The technical schemes in various embodiments may also be combined as appropriate to form other embodiments that can be understood by those skilled in the art.

1. A patch antenna composed of several sets of bonding wires, which are connected to each other, placed in radiating slots on one side of the patch, and combined into different antenna lengths.

2. A patch antenna composed of bonding wires according to claim 1, wherein the manner in which the bonding wires are combined into different antenna lengths includes a combination of different numbers of the bonding wires, a combination of the bonding wires with different lengths, and a combination of the bonding wires with different heights.

3. The application of a patch antenna comprising bonding wires in the millimeter wave technology according to claim 1.
